(19) United States
(12) Patent Application Publication
(10) Pub. No.: US 2017/0267488 A1
(43) Pub. Date: Sep. 21, 2017

(54) ELEVATOR INSTALLATION WITH A SAFETY DEVICE FOR AN ELEVATOR CAR ARRANGEMENT

(71) Applicant: Inventio AG, Hergiswil (CH)

(72) Inventor: Hans Kocher, Udligenswil (CH)

(21) Appl. No.: 15/532,143

(22) PCT Filed: Dec. 2, 2015
(86) PCT No.: PCT/EP2015/078387

§ 371 Date: Jun. 1, 2017

(30) Foreign Application Priority Data
Dec. 2, 2014 (EP) 14195757.1

(51) Int. Cl. B66B 5/02; B66B 11/02

(52) U.S. Cl. CPC B66B 5/02; B66B 11/022

(57) ABSTRACT

An elevator system with an elevator car arrangement has a safety device. The elevator car arrangement includes an upper elevator car, a lower elevator car and an elevator car frame, in which frame the elevator cars can be moved in opposite directions. The safety device has an upper instantaneous safety gear for the upper elevator car and a lower instantaneous safety gear for the lower elevator car. The upper instantaneous safety gear includes a remotely tripping unit that can be tripped by the lower elevator car. Furthermore, the lower instantaneous safety gear includes a remotely tripping unit which can be tripped by the upper elevator car.

### FIELD

The invention relates to a safety device for an elevator car arrangement; an elevator car arrangement that has an upper elevator car, a lower elevator car and an elevator car frame; and an elevator system having such an elevator car arrangement. Specifically, the invention relates to the area of the elevator systems, which are designed as so-called double-deck elevator systems.

### BACKGROUND

An elevator having two elevator cars is known from WO 2005/014461 A1, wherein the two elevator cars are coupled to each other in such a way that they can be moved together in an elevator shaft. A vertical distance between the two elevator cars can be adjusted. An adjustment cable is used for this purpose, one end of the adjustment cable being secured to the bottom of the shaft and the other end of the adjustment cable being connected to a counterweight. In addition, the adjustment cable is guided via a traction sheave of an adjustment drive. When the adjustment cable is actuated, the distance between the elevator cars is varied via a roller arrangement on the elevator cars. In this arrangement, each elevator car moves toward the other or moves away from it.

The elevator system known from WO 2005/014461 A1 has the disadvantage that both elevator cars fall in the event of a fault, such as the adjustment cable breaking. It may indeed be possible that a guide is provided for the two elevator cars in their elevator car frame, which is suspended separately. However, even a fall within the frame must be prevented as a general rule to ensure safety.

WO 2012127683 A1 describes a safety device for an elevator car arrangement that has an upper elevator car, a lower elevator car and an elevator car frame in which the upper elevator car and the lower elevator car can be moved in opposite directions, as well as an upper instantaneous safety gear for the upper elevator car and a lower instantaneous safety gear for the lower elevator car, the upper instantaneous safety gear having a remotely trippable unit that can be tripped by the lower elevator car, and the lower instantaneous safety gear having a remotely trippable unit that can be tripped by the upper elevator car. In this safety device, a first end of a trip cable is securely connected to a trip lever of the lower instantaneous safety gear. The trip cable is guided above the upper elevator car via two rollers on the elevator car frame and extends through an opening in a trip lever of the upper instantaneous safety gear. A counterweight is arranged on the second end of the trip cable and a catch is arranged between the counterweight and the trip lever of the upper instantaneous safety gear. If the two elevator cars do not move in opposite directions relative to each other, the catch strikes the trip lever of the upper instantaneous safety gear and pivots it, thereby activating the upper instantaneous safety gear. Once the trip lever of the upper instantaneous safety gear has been pivoted all the way, the trip lever of the lower instantaneous safety gear is then pivoted, which activates the lower instantaneous safety gear. The two instantaneous safety gears are thus not activated simultaneously, but consecutively.

### SUMMARY

The object of the invention is to specify a safety device for an elevator car arrangement, an elevator car arrangement, and an elevator system that have an improved design. Specifically, the object of the invention is to provide a safety device for an elevator car arrangement, an elevator car arrangement, and an elevator system that guarantee instantaneous safety functions for the elevator cars of the elevator car arrangement in the event of various safety-related faults so that undesired movements of the two elevator cars are prevented.

This object is achieved by a safety device for an elevator car arrangement that has an upper elevator car, a lower elevator car and an elevator car frame in which the upper elevator car and the lower elevator car can be moved in opposite directions, as well as an upper instantaneous safety gear for the upper elevator car and a lower instantaneous safety gear for the lower elevator car, the upper instantaneous safety gear having a remotely trippable unit that can be tripped by the lower elevator car, and the lower instantaneous safety gear having a remotely trippable unit that can be tripped by the upper elevator car.

According to the invention, the remotely trippable unit of the upper instantaneous safety gear is connected via a deflected trip line which is connected to a fixed point that is stationary relative to the lower elevator car, and the remotely trippable unit of the lower instantaneous safety gear is connected via a deflected trip line which is connected to a fixed point that is stationary relative to the upper elevator car. The two remotely trippable units can be tripped if the upper elevator car and the lower elevator car do not move in opposite directions relative to each other in the reference system of the elevator car frame. This allows the remotely trippable unit of the upper instantaneous safety gear to be tripped for the upper elevator car starting from the lower elevator car. Thanks to the aforementioned connection of each of the trip lines to a fixed point relative to the lower or upper elevator car, both remotely trippable units can be tripped simultaneously and the second remotely trippable unit is not tripped only after the first remotely trippable unit has been tripped. This ensures that both elevator cars can be locked simultaneously without delay in the event of a safety-related fault that requires both elevator cars to be locked.

The aforementioned fixed points can, in particular, be arranged on the lower or upper elevator car.

In addition, the object is achieved by an elevator car arrangement that has an upper elevator car, a lower elevator car and an elevator car frame, the upper elevator car and the lower elevator car being movable in opposite directions in the elevator car frame, a safety device having an upper instantaneous safety gear for the upper elevator car and a lower instantaneous safety gear for the lower elevator car being provided, the upper instantaneous safety gear having a remotely trippable unit that can be tripped by the lower elevator car, and the lower instantaneous safety gear having a remotely trippable unit that can be tripped by the upper elevator car. The remotely trippable unit of the upper instantaneous safety gear is connected via a deflected trip line which is connected to a fixed point that is stationary relative to the lower elevator car, and the remotely trippable unit of the lower instantaneous safety gear is connected via a deflected trip line which is connected to a fixed point that is stationary relative to the upper elevator car. The two remotely trippable units can be tripped if the upper elevator car and the lower elevator car do not move in opposite directions relative to each other in the reference system of the elevator car frame.

Furthermore, the object is achieved by an elevator system having such an elevator car arrangement, the elevator car frame being suspended on a tension means and it being possible to move the elevator car frame along with the upper elevator car and the lower elevator car via a drive machine unit that acts on the tension means in a travel space provided for the elevator car arrangement.

In addition, solutions and suggestions that achieve aspects of the stated object are introduced below. Furthermore, advantageous supplemental or alternative further developments and embodiments are specified.

The upper elevator car and the lower elevator car of the elevator car arrangement can be adjusted relative to each other in a suitable manner. Preferably, the elevator cars are adjusted by the same distance toward or away from each other in the reference system of the elevator car frame during an adjustment. The adjusting drive for the elevator car frame can, if necessary, be set up independently of this adjustment mechanism to move the arrangement out of the elevator cars and the elevator car frame through the elevator shaft. The movement of the two elevator cars relative to each other, for example, allows for adaptation to a different distance between floors.

The safety device according to the invention for the elevator car arrangement can be provided independently of the other components of the elevator system. Specifically, the elevator cars and the elevator car frame are not components of the safety device according to the invention. The safety device can therefore also be produced and distributed independently of such components of an elevator system. Where appropriate, the safety device can also be integrated into an existing design of an elevator system without modification or without significant modification.

It is advantageous that a deflection sheave which is secured to the elevator car frame above the remotely trippable unit of the upper instantaneous safety gear is provided, around which the trip line, which is connected to the fixed point that is stationary relative to the lower elevator car, is deflected. Specifically, this fixed point can be arranged on the lower elevator car to which the trip line is secured. If the elevator cars move in opposite directions relative to each other with a deviation, it causes the tension of the trip line to increase and then causes the brake pads or the like of the remotely trippable unit of the upper instantaneous safety gear to engage. This makes reliable activation in a mechanical manner possible.

It is advantageous that a deflection sheave which is secured to the elevator car frame above the fixed point that is stationary relative to the upper elevator, around which the trip line, which is connected to the fixed point that is stationary relative to the upper elevator, is deflected. Thus, reliable activation can also be achieved in a mechanical manner for the remotely trippable unit on the lower elevator car. For example, a brake pad can be engaged by increased tensioning of the trip line.

It is also advantageous that a suspension means is provided which is connected to the upper elevator car at one end and to the lower elevator car at the other end, that a compensation cable is provided which is connected to the upper elevator car at one end and to the lower elevator car at the other end, that the suspension means and the compensation cable are deflected in such a way that an upward movement of the lower elevator car forces an equal downward movement of the upper elevator car and that an upward movement of the upper elevator car forces an equal downward movement of the lower elevator car. Of course, this forced opposite movement of the upper and lower elevator cars is only ensured when the suspension means and compensation cable are intact, that is, during normal operation of the elevator system.

This compensation cable allows the elevator cars to be mutually blocked. If, for example, the upper elevator car does not move, an upward movement of the lower elevator car is prevented. At the same time, the consequence of tripping the remotely trippable unit on the upper elevator car is therefore that the lower elevator car can no longer be moved upward. A corresponding situation arises with respect to the condition that an upward movement of the upper elevator car forces an equal downward movement of the lower elevator car. Because of this, the instantaneous safety gears on the elevator cars can be designed in a simpler manner. This is because the mutual blocking simplifies the tripping of the units of the instantaneous safety gears.

However, in a modified embodiment it is possible that the units, in particular the remotely trippable units, of the instantaneous safety gears can be tripped in both directions. It is advantageous in this case that the remotely trippable unit can be tripped on the upper elevator car if the upper elevator car and the lower elevator car do not move in opposite directions relative to each other. This can be achieved, for example, by guiding another trip line around a deflection sheave provided at the bottom of the elevator car frame. Accordingly, it is advantageous in this case that the remotely trippable unit can be tripped on the lower elevator car if the upper elevator car and the lower elevator car do not move in opposite directions relative to each other. This can also be realized by another trip line that is guided around a deflection sheave arranged at the bottom of the elevator car frame.

It is also advantageous that the upper instantaneous safety gear has a locally trippable device which can be tripped on the upper elevator car. In addition, it is advantageous that the lower instantaneous safety gear has a locally trippable device which can be tripped on the lower elevator car. Specifically, the locally trippable unit of the upper instantaneous safety gear can be mounted on the upper elevator car and the locally trippable unit of the lower instantaneous safety gear can be mounted on the lower elevator car. This makes it possible, for example, to block the respective elevator car via its locally trippable unit if a preset acceleration and/or speed is exceeded relative to the elevator car frame.

Such a locally trippable unit is realized, for example, mechanically by an overspeed cable arrangement or electronically by a position determining unit that determines a position and/or a speed of the elevator cars within the frame via a sensor and an electronic evaluation unit.

It is also advantageous that the upper instantaneous safety gear blocks any movement of the upper elevator car relative to the elevator car frame and, if necessary, catches it from a moving state if at least one unit of the upper instantaneous safety gear is tripped. Accordingly, it is advantageous that the lower instantaneous safety gear locks any movement of the lower elevator car relative to the elevator car frame and, if necessary, catches it from a moving state if at least one unit of the lower instantaneous safety gear is tripped. For this purpose, for example, one or more brake rails can be provided on the elevator car frame that cooperate with brake pads of the units of the instantaneous safety gears when a unit is tripped.

### DESCRIPTION OF THE DRAWINGS

Preferred exemplary embodiments of the invention are explained in more detail in the description below on the basis of the attached drawings, in which corresponding elements are denoted by the same reference numbers. In the drawing:

FIG. 1 shows a partial, schematic illustration of an elevator system having a safety device for an elevator car arrangement corresponding to a first exemplary embodiment of the invention.

### DETAILED DESCRIPTION

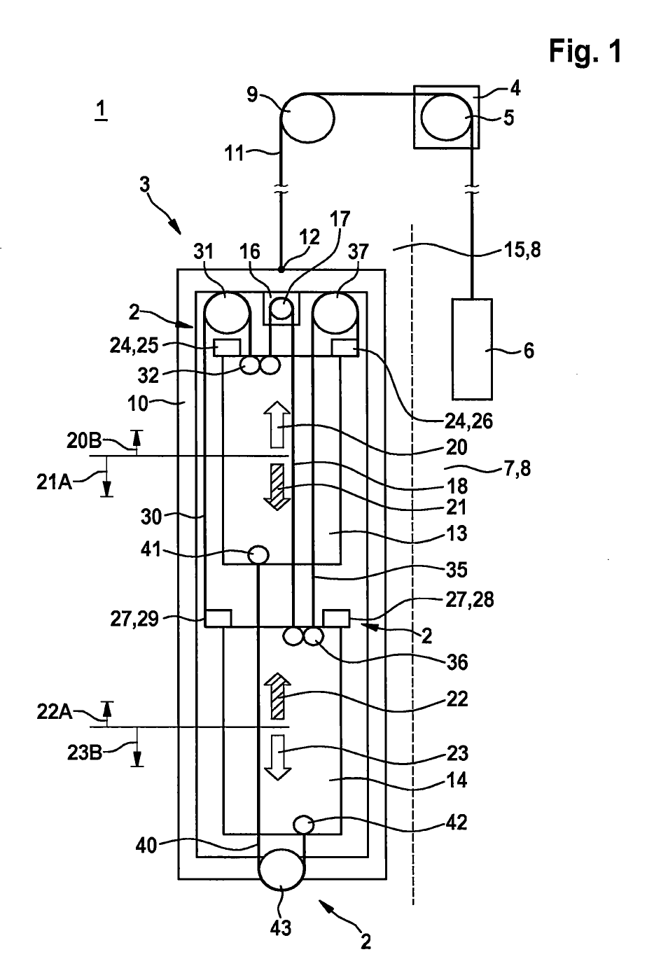

FIG. 1 shows a partial, schematic illustration of an elevator system 1 having a safety device 2 for an elevator car arrangement 3 corresponding to a first exemplary embodiment. Elevator system 1 has a drive machine unit 4 and a traction sheave 5 driven by drive machine unit 4. In addition, a counterweight 6 is provided that can be moved vertically in a subspace 7 of an elevator shaft 8. In addition, a deflection sheave 9 is provided that is arranged above an elevator car frame 10 of elevator car arrangement 3. At one end, a tension means or device 11 is connected to elevator car frame 10 at a fastening point 12. At the other end, tension means 11 is connected to counterweight 6. Tension means 11 runs around both deflection sheave 9 and traction sheave 5.

An upper elevator car 13 and a lower elevator car 14 are arranged in elevator car frame 10. When drive machine unit 4 actuates tension means 11 via traction sheave 5, elevator car frame 10 is moved along with elevator cars 13, 14 in a travel space 15 of elevator shaft 8 provided for the shared travel of elevator cars 13, 14. Travel space 15 is separated from subspace 7 for counterweight 6.

Elevator system 1 also has an adjusting drive 16 having a traction sheave 17. A suspension means or device 18 is connected to upper elevator car 13 at one end and to lower elevator car 14 at the other end. Suspension means 18 is guided around traction sheave 17 of adjusting drive 16 and thus deflected at traction sheave 17. This forms an adjustment mechanism 16, 17, 18 that serves to adjust elevator car 13, 14 relative to elevator car frame 10. Upper elevator car 13 and lower elevator car 14 are moved in opposite directions in elevator car frame 10 by the adjusting drive.

Adjustment mechanism 16, 17, 18 for the adjustment of elevator cars 13, 14 relative to each other and the manner of operation of safety device 2 are described in the reference system of elevator car frame 10. A movement of elevator car frame 10 can be superimposed on this by travel space 15.

Elevator cars 13, 14 can be adjusted within elevator car frame 10. An upward movement 20 of upper elevator car 13 and a downward movement 21 of upper elevator car 13, as well as an upward movement 22 of lower elevator car 14 and a downward movement 23 of lower elevator car 14 are made possible here. Adjustment mechanism for elevator cars 13, 14 within elevator car arrangement 3 is designed in such way that an equal downward movement 23 of lower elevator car 14 occurs at the same time as an upward movement 20 of upper elevator car 13. Accordingly, an equal upward movement 22 of lower elevator car 14 is carried out when there is a downward movement 21 of upper elevator car 13. Suitable guide rails can be provided on elevator car frame 10 for this adjustment mechanism to make it possible to guide elevator cars 13, 14 within elevator car frame 10.

The manner of operation of safety device 2 is based on the movement of upper and lower elevator cars 13, 14 in opposite directions. As a result of a fault that causes a downward movement 21A of upper elevator car 13, which is larger than an upward movement 22A of lower elevator car 14, at least one remotely tripping or trippable unit 26, 29 of safety device 2 is tripped. The at least one remotely tripping unit 26, 29 is, for example, tripped if suspension means 18, on which upper and lower elevator cars 13, 14 are suspended, is torn. In response, both upper and lower elevator cars 13, 14 transition into an uncontrolled downward movement. The downward movement of upper elevator car 13 is therefore greater than the upward movement of lower elevator car 14, the upward movement being viewed here as a negative movement, namely in the opposite direction.

An upper instantaneous safety gear 24 having a locally tripping or trippable unit 25 and a remotely tripping or trippable unit 26 is arranged on upper elevator car 13. A lower instantaneous safety gear 27 having a locally tripping or trippable unit 28 and a remotely tripping or trippable unit 29 is arranged on lower elevator car 14. Locally tripping unit 25 can be tripped on upper elevator car 13. For example, if a predetermined speed or a predetermined acceleration is exceeded, catching and locking of upper elevator car 13 can be achieved by locally tripping unit 25. Accordingly, in the event of a fault on lower elevator car 14, catching and locking lower elevator car 14 can be achieved by locally tripping unit 28.

If lower elevator car 14 moves upward according to upward movement 22A, a corresponding length of trip line 30 is released. Trip line 30 initially runs upward from remotely tripping unit 29, then around a deflection sheave 31 secured to elevator car frame 10 and from there back down to a fixed point 32, which illustrates an attachment of trip line 30 to upper elevator car 13. In this case, downward movement 21A of upper elevator car 13 exceeds the released length of trip line 30, which results in a pulling force on remotely tripping unit 29 of lower instantaneous safety gear 27 starting approximately from the moment the released length was exceeded. The pulling force on remotely tripping unit 29 of lower instantaneous safety gear 27, which is transmitted via trip line 30, requires, for example, the engagement of a safety brake for catching and locking lower elevator car 14.

In this case, the interaction of trip line 30 secured to fixed point 32 with remotely tripping unit 29 thus results in the tripping of remotely tripping unit 29 of lower instantaneous safety gear 27, which locks lower elevator car 14.

Upward movement 22A of lower elevator car 14 also results in the release of a corresponding length of a trip line 35. Trip line 35 is connected to lower elevator car 14 at a fixed point 36. Trip line 35 initially runs upward from fixed point 36, then around a deflection sheave 37 secured to the top of elevator car frame 10 and from there back down to remotely tripping unit 26 of upper instantaneous safety gear 24.

Downward movement 21A of upper elevator car 13 exceeds upward movement 22A of lower elevator car 14. From the moment this upward movement is exceeded, a pulling force transmitted via trip line 35 acts on remotely tripping unit 26 of upper instantaneous safety gear 24. This pulling force results in the tripping of remotely trippable unit 26 of upper instantaneous safety gear 24. This results in the catching and locking of the movement of upper elevator car 13.

Thus, in the illustrated situation in which downward movement 21A of upper elevator car 13 is greater than upward movement 22A of lower elevator car 14 due to a fault, catching and locking of both elevator cars 13 and 14 is achieved by safety device 2.

In the following, a situation is considered in which, as a result of a fault, an upward movement 20B of upper elevator car 13 is smaller than a downward movement 23B of lower elevator car 14. In this case, a length of trip line 30 is released by upward movement 20B of upper elevator car 13, which is, however, exceeded by downward movement 23B of lower elevator car 14. Thus, from the moment this length is exceeded, remotely tripping unit 29 of lower instantaneous safety gear 27 is tripped. This results in the movement of lower elevator car 14 being caught and locked.

Accordingly, the length of trip line 35 released by upward movement 20B of upper elevator car 13 is smaller than is necessary for downward movement 23B of lower elevator car 14. This causes a pulling force on remotely tripping unit 26 of upper instantaneous safety gear 24. Accordingly, this results in the tripping of remotely trippable unit 26 of upper instantaneous safety gear 24. This results in the catching and locking of upper elevator car 13. Thus, both elevator cars 13, 14 are locked in this case as well.

If, however, upward movement 20 of upper elevator car 13 is always equal to the simultaneous downward movement 23 of lower elevator car 14 and downward movement 21 of upper elevator car 13 is always equal to the simultaneous upward movement 22 of lower elevator car 14, then neither remotely trippable unit 26 of upper instantaneous safety gear 24 nor remotely trippable unit 29 of lower instantaneous safety gear 27 are tripped.

In the first exemplary embodiment of the invention described, an upward movement 20 of upper elevator car 13 that is greater than a downward movement 23 of lower elevator car 14 is structurally prevented. An upward movement 22 of lower elevator car 14 that is greater than a downward movement 21 of upper elevator car 13 is also structurally prevented.

For this purpose, a compensation cable 40 is provided that is connected to upper elevator car 13 at an attachment point 41 at one end and to lower elevator car 14 at an attachment point 42 at the other end. In addition, compensation cable 40 is guided via a deflection sheave 43 that is secured to elevator car frame 10. An upward movement 20 of upper elevator car 13 thus forces an equal downward movement 23 of lower elevator car 14. Accordingly, an upward movement of lower elevator car 14 forces an equal downward movement 21 of upper elevator car 13.

The following safety functions result from this. If locally tripping unit 25 of upper instantaneous safety gear 24 locks upper elevator car 13, a further upward movement 22 of lower elevator car 14 is also blocked via compensation cable 40. If locally tripping unit 28 of lower instantaneous safety gear 27 locks lower elevator car 14, a further upward movement 20 of upper elevator car 13 is also blocked via compensation cable 40.

Thus, in the first exemplary embodiment, remotely tripping units 26, 29 need to be designed only for one-sided use to a certain extent.

In a second exemplary embodiment of elevator system 1 having safety device 2, remotely tripping unit 26 of upper instantaneous safety gear can also be tripped if a downward movement 21 of upper elevator car 13 is smaller than an upward movement 22 of lower elevator car 14 or an upward movement 20 of upper elevator car 13 is greater than a downward movement 23 of lower elevator car 14 in the reference system of elevator car frame 10, for example if compensation cable 40 is torn. Accordingly, remotely trippable unit 29 of lower instantaneous safety gear 27 can also be tripped if a downward movement 21 of upper elevator car 13 is smaller than an upward movement 22 of lower elevator car 14 or an upward movement 20 of upper elevator car 13 is greater than a downward movement 23 of lower elevator car 14 in the reference system of elevator car frame 10. Such a design can be achieved, for example, via further trip lines that are guided around deflection sheaves installed in the lower part of elevator car frame 10. This corresponds to a symmetrical design, as is described using trip lines 30, 35 and deflection sheaves 31, 37. For the sake of clarity, the further trip lines and the further deflection sheaves are not shown in FIG. 1.

According to this second exemplary embodiment of safety device 2, a first further trip line is connected to a first further fixed point that is stationary relative to upper elevator car 13. The first further trip line is guided downward from the first further fixed point to a first further deflection sheave, deflected at this first further deflection sheave and guided from there back up to remotely tripping unit 26 of upper instantaneous safety gear 24. Finally, the first further trip line is connected to remotely tripping unit 26 of upper instantaneous safety gear 24.

Furthermore, a second further trip line is connected to a second further fixed point that is stationary relative to lower elevator car 14. The second further trip line is guided downward from the second further fixed point to a second further deflection sheave, deflected at this second further deflection sheave and guided from there back up to remotely tripping unit 29 of lower instantaneous safety gear 27. Finally, the second further trip line is connected to remotely tripping unit 29 of upper instantaneous safety gear 27.

Thus, it is possible for remotely trippable unit 26 of upper instantaneous safety gear 24 to be tripped via deflected trip line 35, which can be connected to fixed point 36 that is stationary relative to lower elevator car 14, if a downward movement 21A of upper elevator car 13 is greater than an upward movement 22A of lower elevator car 14 or an upward movement 20B of upper elevator car 13 is smaller than a downward movement 23B of lower elevator car 14 in the reference system of elevator car frame 10. Remotely trippable unit 26 of upper instantaneous safety gear 24 can of course also be tripped if a downward movement 21A of upper elevator car 13 occurs in the reference system of elevator car frame 10 while lower elevator car 14 remains stationary or even moves downward. Accordingly, remotely trippable unit 26 of upper instantaneous safety gear 24 can of course also be tripped if a downward movement 23B of lower elevator car 14 occurs in the reference system of elevator car frame 10 while upper elevator car 13 remains stationary or even moves downward.

In summary, remotely trippable unit 26 of upper instantaneous safety gear 24 can be tripped via deflected trip line 35, which can be connected to the fixed point 36 that is stationary relative to lower elevator car 14, if upper elevator car 13 and lower elevator car 14 do not move in opposite directions relative to each other in the reference system of elevator car frame 10.

In addition, it is possible for remotely trippable unit 29 of lower instantaneous safety gear 27 to be tripped via a deflected trip line 30, which can be connected to a fixed point 32 that is stationary relative to upper elevator car 13, if a downward movement 21A of upper elevator car 13 is greater than an upward movement 22A of lower elevator car 14 or an upward movement 20B of upper elevator car 13 is smaller than a downward movement 23B of lower elevator car 14 in the reference system of elevator car frame 10. Remotely trippable unit 26 of upper instantaneous safety gear 24 can of course also be tripped if a downward movement 21A of upper elevator car 13 occurs in the reference system of elevator car frame 10 while lower elevator car 14 remains stationary or even moves downward. Accordingly, remotely trippable unit 26 of upper instantaneous safety gear 24 can of course also be tripped if a downward movement 23B of lower elevator car 14 occurs in the reference system of elevator car frame 10 while upper elevator car 13 remains stationary or even moves downward.

In summary, remotely trippable unit 29 of lower instantaneous safety gear 27 can be tripped via deflected trip line 30, which can be connected to fixed point 32 that is stationary relative to upper elevator car 13, if upper elevator car 13 and lower elevator car 14 do not move in opposite directions relative to each other in the reference system of elevator car frame 10.

The invention is not limited to the described exemplary embodiments and modifications.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. A safety device for an elevator car arrangement having an upper elevator car, a lower elevator car and an elevator car frame, in which frame the upper elevator car and the lower elevator car can be moved in opposite directions, comprising:
an upper instantaneous safety gear for the upper elevator car;
a lower instantaneous safety gear for the lower elevator car;
wherein the upper instantaneous safety gear has a remotely trippable unit that can be tripped by the lower elevator car, and the lower instantaneous safety gear has a remotely trippable unit that can be tripped by the upper elevator car;
wherein the remotely trippable unit of the upper instantaneous safety gear is connected to a first deflected trip line that is connected to a first fixed point that is stationary relative to the lower elevator car;
wherein the remotely trippable unit of the lower instantaneous safety gear is connected via a second deflected trip line that is connected to a second fixed point that is stationary relative to the upper elevator car; and
wherein the two remotely trippable units are tripped if the upper elevator car and the lower elevator car do not move in opposite directions relative to each other in a reference system of the elevator car frame.

12. The safety device according to claim 11 including a deflection sheave secured to the elevator car frame above the remotely trippable unit of the upper instantaneous safety gear around which the second deflected trip line is deflected.

13. The safety device according to claim 11 including a deflection sheave secured to the elevator car frame above the second fixed point around which the second deflected trip line is deflected.

14. The safety device according to claim 11 including a suspension device connected to the upper elevator car at one end and connected to the lower elevator car at another end, a compensation cable connected to the upper elevator car at one end and connected to the lower elevator car at another end, the suspension means and the compensation cable being deflected wherein an upward movement of the lower elevator car forces an equal downward movement of the upper elevator car and an upward movement of the upper elevator car forces an equal downward movement of the lower elevator car.

15. The safety device according to claim 14 including a deflection sheave secured to the elevator car frame below an attachment point of the compensation cable to the lower elevator car around which the compensation cable is deflected.

16. The safety device according to claim 11 wherein at least one of the remotely trippable unit of the upper instantaneous safety gear is tripped if the upper elevator car and the lower elevator car do not move in opposite directions relative to each other in the reference system of the elevator car frame, and the remotely trippable unit of the lower instantaneous safety gear is tripped if the upper elevator car and the lower elevator car do not move in opposite directions relative to each other in the reference system of the elevator car frame.

17. The safety device according to claim 11 wherein at least one of the upper instantaneous safety gear has a locally trippable unit that can be tripped on the upper elevator car, and the lower instantaneous safety gear has a locally trippable unit which can be tripped on the lower elevator car.

18. The safety device according to claim 11 wherein at least one of the upper instantaneous safety gear blocks any movement of the upper elevator car relative to the elevator car frame and, if necessary, catches the upper elevator car from a moving state if at least one unit of the upper instantaneous safety gear is tripped, and the lower instantaneous safety gear blocks any movement of the lower elevator car relative to the elevator car frame and, if necessary, catches the lower elevator car from a moving state if at least one unit of the upper instantaneous safety gear is tripped.

19. An elevator car arrangement that has an upper elevator car, a lower elevator car and an elevator car frame, wherein the upper elevator car and the lower elevator car move in opposite directions within the elevator car frame, comprising:
a safety device having an upper instantaneous safety gear for the upper elevator car and a lower instantaneous safety gear for the lower elevator car, the upper instantaneous safety gear having a remotely trippable unit that can be tripped by the lower elevator car and the lower instantaneous safety gear having a remotely trippable unit that can be tripped by the upper elevator car;
the remotely trippable unit of the upper instantaneous safety gear being connected via a first deflected trip line to a first fixed point that is stationary relative to the lower elevator car;
the remotely trippable unit of the lower instantaneous safety gear being connected via a second deflected trip line to a second fixed point that is stationary relative to the upper elevator car; and
the two remotely trippable units being tripped if the upper elevator car and the lower elevator car do not move in opposite directions relative to each other in a reference system of the elevator car frame.

20. The elevator car arrangement according to claim 19 wherein the elevator car frame is suspended on a tension device and wherein the elevator car frame along with the upper elevator car and the lower elevator car are moved via a drive machine unit acting on the tension device in a travel space provided for the elevator car arrangement.
